(19) United States
(12) Patent Application Publication
(10) Pub. No.: US 2014/0238428 A1
(43) Pub. Date: Aug. 28, 2014

(54) Nose and Ear Trimmer for Disposable Razor

(71) Applicant: Ryan James Lawliss, Spring Valley, CA (US)

(72) Inventor: Ryan James Lawliss, Spring Valley, CA (US)

(21) Appl. No.: 14/179,554

(22) Filed: Feb. 12, 2014

Related U.S. Application Data
(60) Provisional application No. 61/850,201, filed on Feb. 12, 2013.

(51) Int. Cl. B26B 19/26; B26B 21/40; B26B 21/06

(52) U.S. Cl. CPC B26B 19/265; B26B 21/06; B26B 21/4081
USPC 132/200; 30/29.5

(57) ABSTRACT

A nose and ear trimmer for disposable razor includes a handle having a first and second end; a razor blade for shaving on the first end of the handle; a nose and ear trimmer at the second end of the handle, the nose and ear trimmer including a circular blade, and alternating fingers and slits, where the slits expose a portion of the blade.

### RELATED APPLICATIONS

This application claims the benefit of the filing date of U.S. Patent Application No. 61/850,201, filed Feb. 12, 2013, which is incorporated herein by reference in its entirety.

### BACKGROUND OF THE INVENTION

The present invention generally relates to grooming products and more specifically to a nose and ear trimmer for a disposable razor.

Nose and ear trimmers usually are generally electric devises that plug in to the wall or battery powered. Typical disposable razors generally do not have the capability of trimming hair in the nose and ear areas.

A manual nose and ear trimmer that is located on the butt of a disposable razor may have the convenience to shave ones face and cut the hair in the ear and nose. It would be desirable to have a nose and ear trimmer included with a razor.

### SUMMARY OF THE INVENTION

In one aspect of the present invention, a nose and ear trimmer for disposable razor includes a handle having a first and second end; a razor blade for shaving on the first end of the handle; a nose and ear trimmer at the second end of the handle, the nose and ear trimmer including a circular blade, and alternating fingers and slits, where the slits expose a portion of the blade.

### BRIEF DESCRIPTION OF THE DRAWINGS

FIG. 1 depicts an embodiment of the present invention;

FIG. 2 depicts the embodiment of FIG. 1 with a cap; and

FIGS. 3A,B through 8 depict embodiments of a nose and ear trimmer for a razor.

### DETAILED DESCRIPTION

The preferred embodiment and other embodiments, which can be used in industry and include the best mode now known of carrying out the invention, are hereby described in detail with reference to the drawings. Further embodiments, features and advantages will become apparent from the ensuing description, or may be learned without undue experimentation. The figures are not necessarily drawn to scale, except where otherwise indicated. The following description of embodiments, even if phrased in terms of “the invention” or what the embodiment “is,” is not to be taken in a limiting sense, but describes the manner and process of making and using the invention. The coverage of this patent will be described in the claims. The order in which steps are listed in the claims does not necessarily indicate that the steps must be performed in that order.

An embodiment of the present invention generally provides a nose and ear trimmer for a disposable razor.

A manual nose and ear trimmer that is located on the butt of a disposable razor may have the convenience to shave ones face and cut the hair in the ear and nose. Various configurations may be provided to attach a nose and ear trimmer to the end of the razor. An embodiment of a trimmer may include a safety nose and ear trimmer with an optional cap for added safety.

In one embodiment a manual nose and ear trimmer for a disposable razor may have a crown with small slits for the hair to maneuver toward the round blade for cutting hair. Plastic fingers spaced around an appropriate radius may protrude just over the top of a round blade, to provide a safety feature. The fingers may keep the blade from scraping against the skin.

In another embodiment, a nose and ear trimmer is covered by a removable cap for extra protection when shaving one's face.

In a manual embodiment, the user may insert the trimmer of the device into an ear or nostril and rotate the handle so that the user's hair slips into the slits between the fingers and forcibly presses against the cutting edge of the blade, so that the blade cuts the hairs without cutting the user's skin. The device may be inexpensive, because it may utilize only manual power and articulation to control the device and trim the user's ear and nose hair, thereby avoiding the need for expensive electrical machinery. This may provide a comfortable and manual way for a user to trim trimming nose and ear hair with an inexpensive, disposable device.

As depicted in FIG. 1, an embodiment of the present invention 10 may include a razor 12 having a handle 14 or other connecting shaft, with a shaving blade 16 at one end and a nose and ear trimmer 20 at the other end or butt of the razor. In alternate embodiments, the device 10 may be disposable, or the device may accept replaceable blades and/or batteries for long-term use. The device may be manually operated, or the handle 14 may contain one or more batteries (not shown) to power the nose and ear trimmer 20.

In a manual embodiment, the male or female user may utilize the conventional shaving blade to shave body hair (e.g. a beard, legs, etc.), and also insert the trimmer end of the device into an ear or nostril and then rotate the device so that the blade safely and conveniently cuts and trims the user's ear or nose hairs. The device may therefore provide multiple grooming solutions in an inexpensive, disposable package.

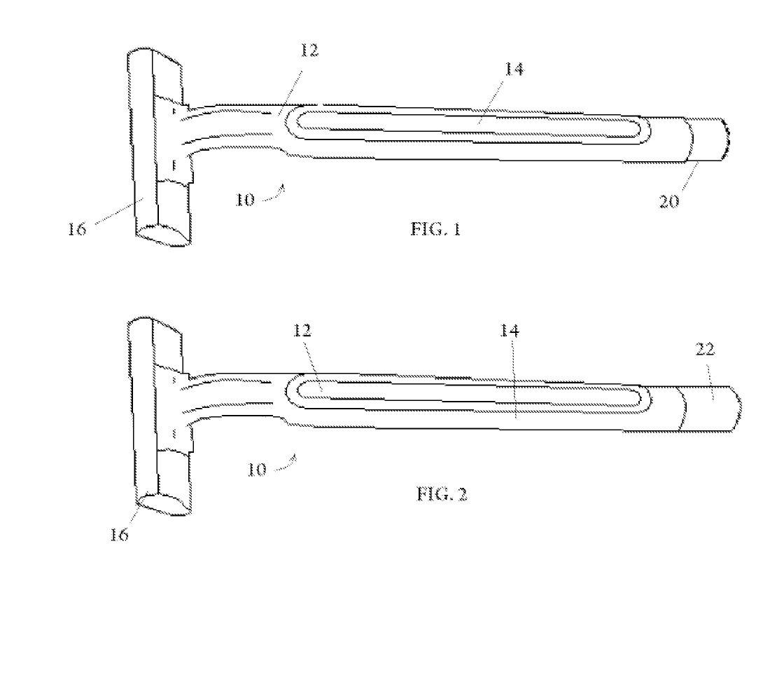

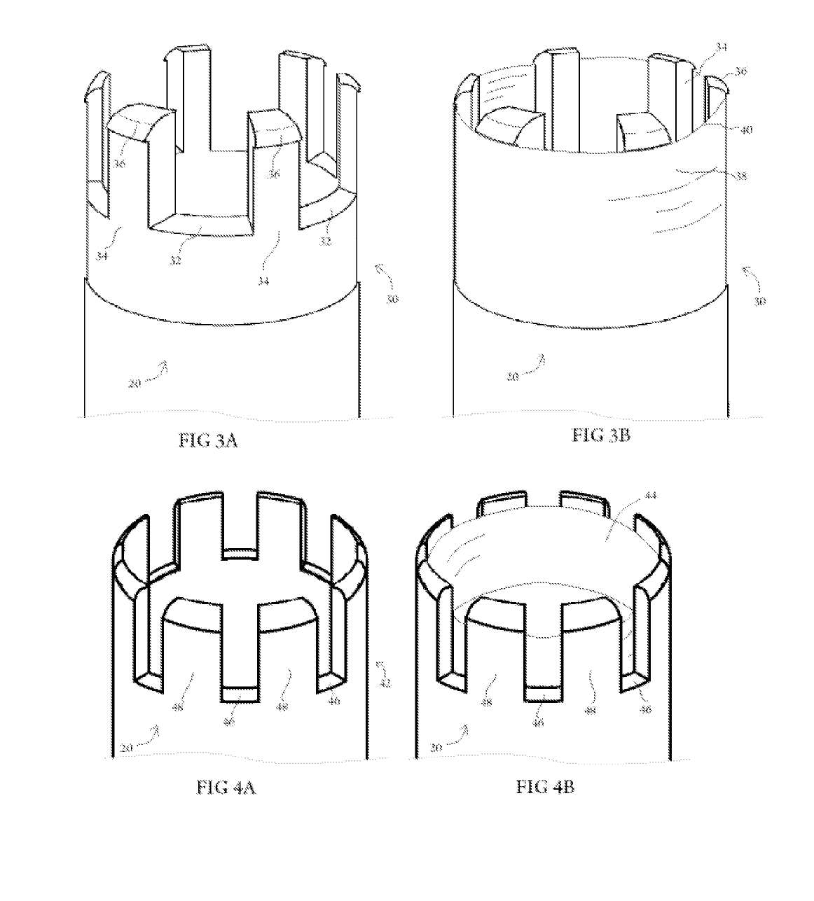

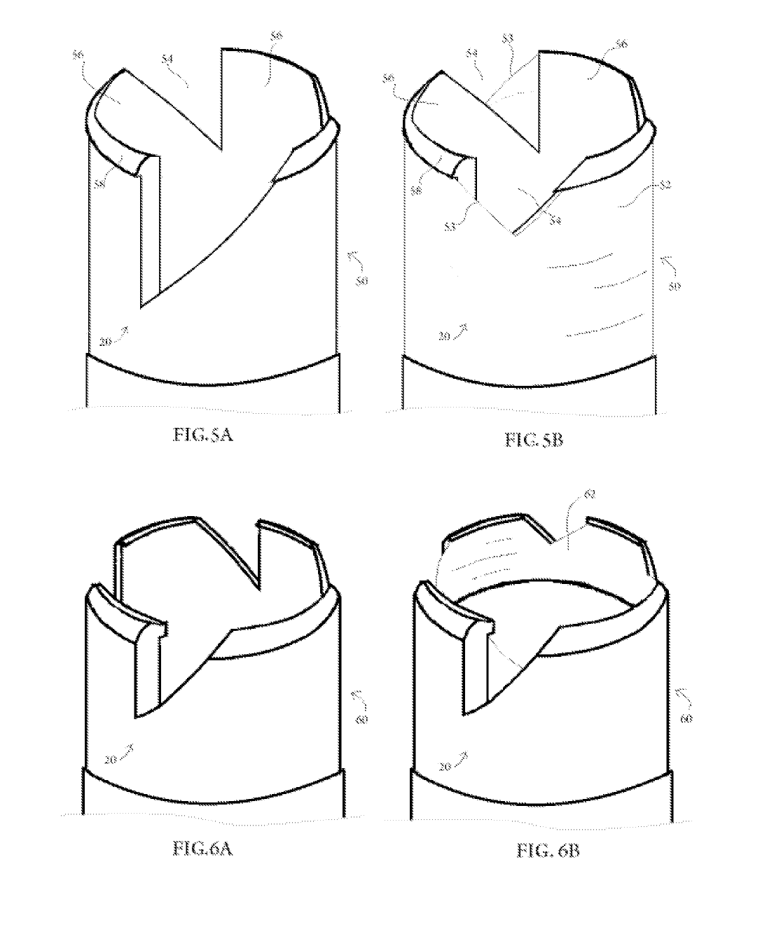

As depicted in FIG. 2, an embodiment 10 may include a razor 12 with a nose and ear trimmer at the butt of the handle 14, and a removable cap 22 that encloses the nose and ear trimmer. The cap may provide a measure of safety, to help prevent users from accidentally hurting themselves by contact with the sharp edge of the razor blades, and also to keep the blades clean and protected when the device is stored.

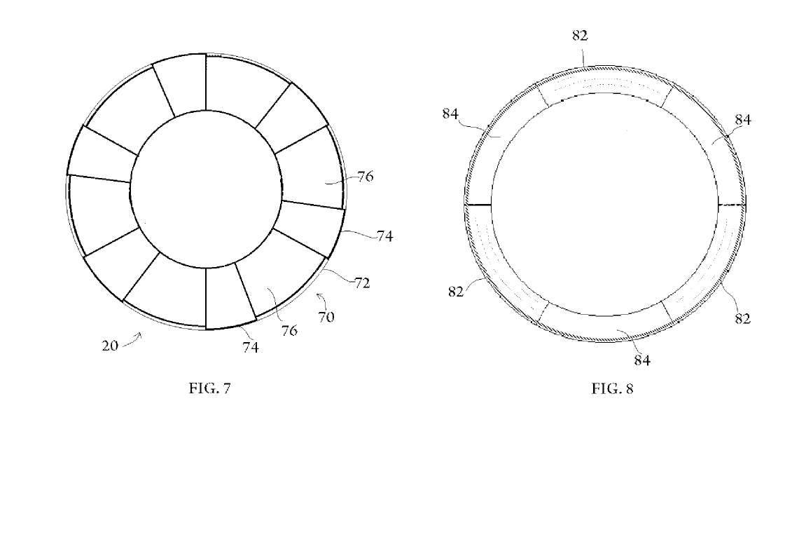

As depicted in FIGS. 3A and 3B, an embodiment of a nose and ear trimmer 20 may be attached to the butt or bottom end of a disposable razor. The nose and ear trimmer 20 may include a crown 30 with a series of slits 32 that encircle the crown. Between the slits 32 are plastic fingers 34 spaced around a rim of the crown 30. The fingers 34 may have small holding tabs 36 that extend outwardly from the crown, to help hold an exterior round razor blade 38 in place on the outside of the crown 30. A blade 38 may encircle and be retained by crown 30 and may be about 1/32 inches shorter than the fingers 34, so that the fingers protrude just over the top sharp edge 40 of the round blade for safety. The slits 32 allow the blade 38 to cut hair in the user's nose or ear, while the fingers 34 help keep the sharp edge of the blade 38 from scraping against the user's skin. In an embodiment having an exterior blade 38, the crown 30 may have a slightly smaller radius than that of the handle of the disposable razor, so that the outside of the blade is flush with the sides of the handle.

As depicted in FIGS. 4A and 4B, an embodiment of a nose and ear trimmer 20 may have a crown 42 that retains an interior round blade 44. Crown 42 may have slits 46 and fingers 48 that retain the blade 44 inside of the crown 42 yet allow the blade 44 to cut hair while protecting the user's skin from coming in contact with the blade 44.

As depicted in FIGS. 5A and 5B, an embodiment of a nose and ear trimmer 20 may have a crown 50 an exterior angled blade 52. This embodiment of a blade 52, rather than having rectangular notches and rectangular fingers, has a right angled, 45 degree, or other non-perpendicular or slanted notch and corresponding angled fingers to allow the user's hair to slide into the angled notch and press against the sharp razor. Embodiments may have an outer plastic crown 50 have slits 54 between fingers 56 at a first angle, such as a right-facing right angle, and the blade edge 53 between the fingers 56 may have a similar but opposite angle, such as a left-facing right angle. As seen in the figures, this may appear to make a “V” shape because of the opposing sides of the fingers and the blade. This angled shape may provide superior performance to an embodiment with only rectangular shapes and angles, because the angled blades may more easily slice into the user's hair and remove the hair, without pulling on the hair and subjecting the user to pain and discomfort. Embodiment may include holding tabs or a holding rim 58 that extends outwardly from the crown 40, to help hold exterior angled blade 52 in place on the outside of the crown 50.

As depicted in FIGS. 6A and 6B, an embodiment of a nose and ear trimmer 20 may have a crown 70 and an interior angled blade 72. This is similar to the embodiment of FIG. 5A-B, but this embodiment has the blade on the inside of the crown.

As depicted in FIG. 7, an embodiment of a nose and ear trimmer 20 may include a crown 70 surrounded by a round blade 72 with a series of slits 74 and fingers 76 that encircle the crown.

As depicted in FIG. 8, an embodiment of a nose and ear trimmer 20 may include a crown 80 with alternating “V” shaped cutting areas 82 and fingers 84 that encircle the crown.

Embodiments may include a manual nose and ear trimming devise for cutting hair. This may include an optional cap. Embodiments may be provided for a regular razor blade or disposable razor blades. The trimmer may be a safety trimmer blade. Embodiments may be cleaned by running water on top of circular blade. Embodiments may include a crown or holder made out of metal or plastic. The ear and nose trimmer blades may be made from metal, ceramic, plastic, alloy, etc. An end crown may be attachable, detachable, or one molded piece.

1. A device including:
a handle having a first and second end;
a razor blade for shaving on the first end of the handle;
a nose and ear trimmer at the second end of the handle, the nose and ear trimmer including a circular blade, and alternating fingers and slits, where the slits expose a portion of the blade.

2. The device of claim 1, further comprising:
a cap that removably covers the nose and ear trimmer

3. A device, comprising:
a light, plastic manual grooming razor having a handle and a base;
a crown at the base of the razor having a circular rim that extends axially away from the razor;
a circular blade retained by the crown so that a sharp edge of the blade extends axially away from the razor; and
a plurality of fingers around the rim of the crown that protrude past the blade, with slits between the fingers that provide access to exposed sections of the sharp edge of the blade.

4. The device of claim 3, wherein the fingers protrude just past the sharp edge of the blade for a short distance so that the device is adapted to cut a user's hair yet prevent the blade from scraping against the user's skin.

5. The device of claim 3, wherein the blade and the handle have a common central axis.

6. The device of claim 3, where the sharp edge of the blade is generally right angled relative to the fingers.

7. The device of claim 3, where the sharp edge of the blade has slanted notches and the crown has corresponding angled slits that cooperate to form “V” shaped notches, which allow a user's hair to slide into the angled notch and press against the sharp edge.

8. The device of claim 3, where the circular blade is interior to the crown and fingers.

9. The device of claim 3, where the circular blade is exterior to the crown and fingers.

10. The device of claim 3, wherein each finger includes a holding tab at a distal end that extends outwardly from the crown, to help hold an exterior round razor blade in place on the outside of the crown.

11. A method for grooming, comprising:
providing a grooming device that includes a handle having a shaver and trimmer end; a razor blade for shaving on the grooming device end of the handle; and a nose and ear trimmer at the trimmer end of the handle, the nose and ear trimmer including a circular blade, and alternating fingers and slits, where the slits expose a portion of the blade;
shaving body hair with the shaver end of the grooming device; and
inserting the trimmer end of the grooming device into an ear or nostril so that the user's hair slips into the slits between the fingers and forcibly presses against the cutting edge of the blade, thereby cutting the hairs without cutting the user's skin.

12. The method of claim 11, further comprising:
after inserting the trimmer end of the device, manually rotating the handle so as to rotate the trimmer within the ear or nostril.
